(19) United States
(12) Patent Application Publication
(10) Pub. No.: US 2024/0006677 A1
(43) Pub. Date: Jan. 4, 2024

(54) RECOVERY OF METALS FROM LITHIUM-ION BATTERIES

(71) Applicants: Alejandro F. GRAF, Canton, MI (US); Eva L. KREPPS, Colorado Springs, CO (US); Eric L. KREPPS, Colorado Springs, CO (US); Erik FLEMING, Newport Beach, CA (US); REDIVIVUS, INC., Colorado Springs, CO (US)

(72) Inventors: Alejandro F. GRAF, Canton, MI (US); Evan L. KREPPS, Colorado Springs, CO (US); Eric L. KREPPS, Colorado Springs, CO (US); Erik FLEMING, Newport Beach, CA (US)

(21) Appl. No.: 18/254,939

(22) PCT Filed: Nov. 30, 2021
(86) PCT No.: PCT/US21/61200

§ 371 Date: May 30, 2023

Related U.S. Application Data
(60) Provisional application No. 63/120,192, filed on Dec. 1, 2020.

(51) Int. Cl. H01M 10/54; C22B 1/02; C22B 7/00; C22B 15/00; C22B 3/22; C22B 3/42; C22B 23/00; C22B 1/26; C22B 3/00; B09B 3/35; B09B 3/40; B09B 3/80; B09B 3/70; C25C 1/24; C25C 1/12; C25C 1/08

(52) U.S. Cl. CPC H01M 10/54; C22B 1/02; C22B 7/007; C22B 7/005; C22B 15/0013; C22B 15/0067; C22B 15/0086; C22B 3/22; C22B 3/42; C22B 15/0089; C22B 23/005; C22B 1/26; C22B 23/0415; C22B 23/0461; B09B 3/35; B09B 3/40; B09B 3/80; B09B 3/70; C25C 1/24; C25C 1/12; C25C 1/08; B09B 2101/16

(57) ABSTRACT

The present disclosure provides methods and systems for recovering metals from lithium-ion batteries, and specifically to methods and systems for recovering cobalt and nickel jointly in metallic form via electrowinning processes. The present disclosure further provides methods and systems for preparing lithium-ion battery materials for use in metal recovery processes.

### CROSS-REFERENCE TO RELATED APPLICATION

This application claims the benefit of priority of U.S. Provisional Patent Application No. 63/120,192, filed 1 Dec. 2020, the entirety of which is incorporated herein by reference.

### FIELD OF THE INVENTION

This invention is directed generally to methods and systems for recovering metals from lithium-ion batteries, and specifically to methods and systems for recovering cobalt and nickel jointly in metallic form via electrowinning processes. The invention is additionally directed to methods and systems for preparing lithium-ion battery materials for use in metal recovery processes.

### BACKGROUND OF THE INVENTION

Many current processes for lithium-ion battery recycling target a “circular” flow of materials, whereby cobalt and nickel are recovered as cathode materials ready to be reused in the production of lithium-ion or other batteries. Such processes, known as “direct recycling” processes, require an intimate knowledge of the various cathode chemistries and structures of the batteries being recycled, but these chemistries and structures are generally closely guarded as secrets by battery manufacturers, making development of the recycling processes very challenging. Another type of battery recycling process uses hydrometallurgical techniques to separate and then selectively precipitate the metal ions of interest as salts; these processes allow for recovery of most battery components, but the recovered metals require additional processing to be returned to a metallic form. A third approach is to melt the entire contents of the battery and separate the metals of interest by exploiting differences in the density of the melted materials or other hydrometallurgical steps, but “pyrometallurgical” methods such as these have very large energy requirements and do not allow for the recovery of all battery components.

More recently, lithium-ion battery recycling processes have focused on the complete separation of cobalt and nickel. While this separation allows for a larger pool of end users due to the ability to control or select the relative amounts of cobalt and nickel in the final product, the chemical similarity between cobalt and nickel require complex, and often expensive and time-consuming, separation techniques.

There is thus a need in the art for methods and systems for recovering metals from lithium-ion batteries that do not involve reactant-driven hydrometallurgical techniques, do not require the processing or disposal of hazardous solvents or other hazardous materials, and are simpler and less costly than processes that involve the separation of cobalt and nickel.

### SUMMARY OF THE INVENTION

In one aspect of the present invention, a method for recovering metals comprises (a) shredding at least one lithium-ion battery to form a shredded material; (b) roasting the shredded material to form a roasted material; (c) acid-leaching the roasted material to form a leach liquor comprising cobalt and nickel; and (d) electrowinning the leach liquor to form a recovered metal product comprising at least about 50% of the cobalt in the leach liquor and at least about 50% of the nickel in the leach liquor.

In embodiments, the leach liquor may further comprise copper, wherein at least most of the copper is recovered from the leach liquor by copper electrowinning. The copper electrowinning may, but need not, be carried out as part of step (d). The copper electrowinning may, but need not, be carried out as an electrowinning step separate from step (d).

In embodiments, a temperature of the lithium-ion battery may be no more than about 0° C. during step (a).

In embodiments, the method may further comprise, between steps (a) and (b), removing steel filings from the shredded material via magnetic separation.

In embodiments, step (b) may be carried out at a temperature of no more than about 450° C.

In embodiments, the method may further comprise, between steps (b) and (c), washing, with a fluid comprising water, and filtering the roasted material to remove fluorine compounds from the roasted material.

In embodiments, an acid used to perform the acid-leaching of step (c) may be selected from the group consisting of sulfuric acid, nitric acid, and combinations and mixtures thereof.

In embodiments, the method may further comprise, between steps (c) and (d), filtering the leach liquor to remove graphite from the leach liquor.

In embodiments, the method may further comprise, between steps (c) and (d) or during step (d), adding a precipitating agent to the leach liquor to form at least one of an aluminum-containing precipitate, a copper-containing precipitate, an iron-containing precipitate, and a carbonate-containing precipitate. The precipitating agent may, but need not, comprise sodium carbonate.

In embodiments, cobalt and nickel may make up at least about 99.7 wt % of the recovered metal product.

In embodiments, copper may make up up no more than about 25 ppmw of the recovered metal product.

In embodiments, the recovered metal product may comprise at least about 80% of the nickel in the leach liquor.

In another aspect of the present invention, a method for preparing a material for use in a metal recovery process comprises: (a) cooling a lithium-ion battery to a temperature at least as low as 0° C.; (b) shredding the lithium-ion battery while maintaining the temperature of the lithium-ion battery at least as low as 0° C., thereby forming a shredded material; (c) washing the shredded material with a fluid comprising water to form a washed material; and (d) packing the washed material for transport.

In embodiments, the temperature in step (a) may be about −80° C. In embodiments, the temperature in step (b) may be about −40° C.

In embodiments, the fluid in step (c) may further comprise a pH buffer or pH control agent.

In embodiments, the shredding of step (b) may produce a vapor and step (b) may comprise the sub-step of remediating the vapor.

In another aspect of the present invention, a method for preparing a material for use in a metal recovery process according to the second aspect is used in combination or conjunction with a method for recovering metals according to the first aspect. In other words, a material may first be prepared according to one or more preparation methods as described herein, and then subjected to metal recovery according to metal recovery methods as described herein.

The advantages of the present invention will be apparent from the disclosure contained herein.

As used herein, “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone,

A and B together, A and C together, B and C together, or A, B, and C together.

It is to be noted that the term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The embodiments and configurations described herein are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1A is a flowchart of an industrial-scale process for physically separating lithium-ion battery components, according to embodiments of the present invention.

FIG. 1B is a flowchart of an industrial-scale process for chemically separating lithium-ion battery components, according to embodiments of the present invention.

FIG. 1C is a flowchart of an industrial-scale process for recovering cobalt and nickel from lithium-ion battery components, according to embodiments of the present invention.

FIG. 2 is a flowchart of a bench-scale process for separating and recovering cobalt and nickel from lithium-ion battery components, according to embodiments of the present invention.

FIG. 3 is an illustration of a system for on-site cooling and shredding of lithium-ion batteries prior to transport, according to embodiments of the present invention.

FIG. 4A is an illustration of a grinding wheel assembly of a shredder used in the process of FIG. 2.

FIG. 4B is an illustration of a shredded material produced by shredding lithium-ion batteries in the grinding wheel assembly depicted in FIG. 4A according to the process depicted in FIG. 2.

FIG. 5 is an illustration of a system for roasting the shredded material depicted in FIG. 4B according to the process depicted in FIG. 2.

FIG. 6 is an illustration of the roasted material produced by the system of Figure

FIG. 7A is an illustration of a system for copper electrowinning of the roasted 30 material depicted in FIG. 6 according to the process depicted in FIG. 2.

FIG. 7B is an illustration of a copper electrowinning product of the system depicted in FIG. 7A.

FIG. 8 is an illustration of a cobalt and nickel electrowinning product of the process depicted in FIG. 2.

### DETAILED DESCRIPTION OF THE INVENTION

Unless defined otherwise, all technical and scientific terms used herein have the same meaning as is commonly understood by one of ordinary skill in the art. All patents, applications, published applications, and other publications to which reference is made herein are incorporated by reference in their entirety. In the event that there is a plurality of definitions for a term herein, the definition provided in the Summary of the Invention prevails unless otherwise stated.

The present invention allows for the recovery of cobalt and nickel jointly in metallic form from lithium-ion batteries via an electrowinning process. This approach is commercially attractive at least because (1) no reactant-driven hydrometallurgical techniques are involved, which eliminates the costs associated with processing and disposal of chemically hazardous solutions; (2) the final product is a cobalt/nickel metallic alloy, eliminating or greatly reducing the need for challenging and costly processing to separate cobalt and nickel; and (3) the cobalt/nickel product can be used as an alloying feedstock to metallurgical operations in the stainless steel and superalloy industries. Although the cobalt/nickel ratio of the product of the methods and systems of the present invention may vary according to the chemistry of the batteries being processed, the battery chemistry has little or no effect on the electrolytic processes of the invention, adding robustness and flexibility to the methods and systems of the invention. Furthermore, this variability can be easily addressed by end users of the cobalt/nickel metallic alloy product, who can adjust the metallurgical loads of their processing steps according to their needs.

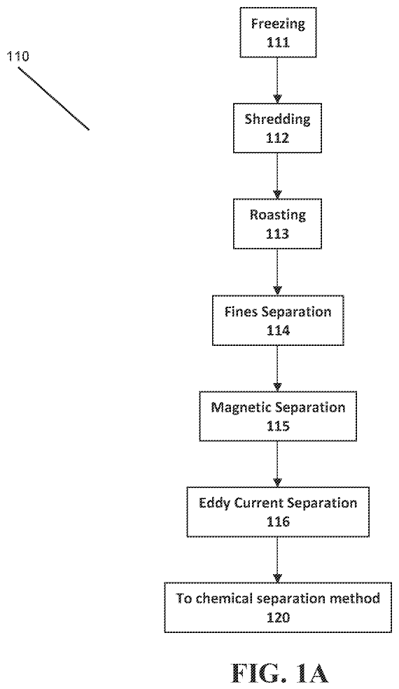

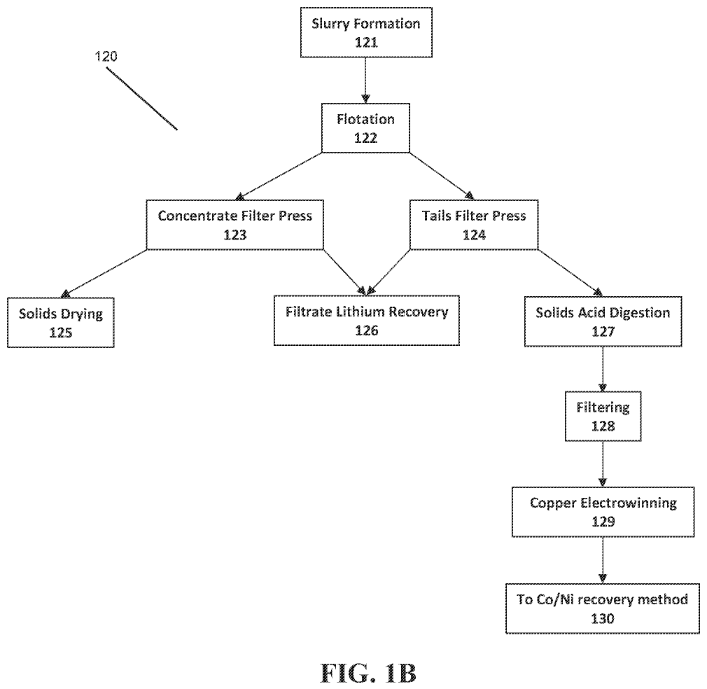

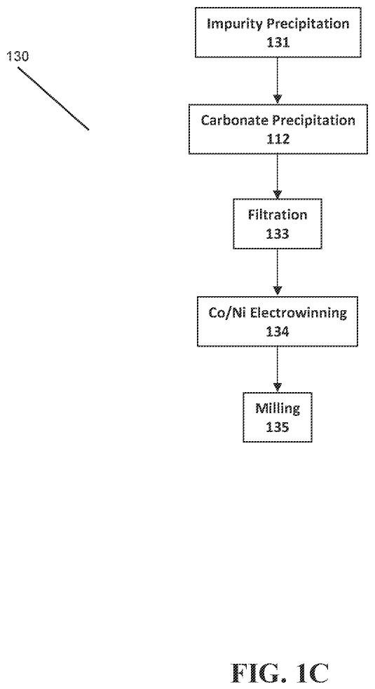

Referring now to FIG. 1A, an embodiment of an industrial-scale process 110 for physically separating lithium-ion battery components is illustrated. In a freezing step 111 of the physical separation process 110, lithium-ion batteries are “frozen,” i.e. cooled to cryogenic temperatures, by being placed in a very low-temperature atmosphere of inert or substantially inert gas, such as a noble gas or nitrogen gas. In a shredding step 112 of the physical separation process 110, the frozen lithium-ion batteries are shredded to produce a shredded material that is amenable to the downstream physical and chemical separation processing steps; the average size of pieces of the shredded material is preferably no more than about 20 mm, more preferably no more than about 19 mm, still more preferably no more than about 18 mm, still more preferably no more than about 17 mm, still more preferably no more than about 16 mm, still more preferably no more than about 15 mm, still more preferably no more than about 14 mm, still more preferably no more than about 13 mm, still more preferably no more than about 12 mm, still more preferably no more than about 11 mm, still more preferably no more than about 10 mm, still more preferably no more than about 9 mm, still more preferably no more than about 8 mm, still more preferably no more than about 7 mm, and still more preferably no more than about 6 mm, to minimize the probability of a thermal event due to the tendency of the pieces of shredded material to “short-circuit.” In a roasting step 113 of the physical separation process 110, the shredded material is roasted to produce a roasted material; the temperature and time of the roasting step 113 is preferably selected to allow for the breakdown of binder materials (e.g. polyvinylidene fluoride (PVFD)) in the lithium-ion batteries and liberation of the cathode powder while preventing oxidation of metallic aluminum and copper. In a fines separation step 114 of the physical separation process 110, the roasted material is screened to eliminate large pieces of aluminum and steel remaining in the roasted material. In a magnetic separation step 115 of the physical separation process 110, remaining steel casings are removed from the roasted material via magnetic separation. The remainder of the roasted material, and optionally the large pieces of aluminum and steel, is/are subjected to an eddy current separation step 116 of the physical separation process 110, in which conventional eddy current separation techniques known to those of ordinary skill in the art may be employed to remove aluminum and copper. After eddy current separation step 116, the roasted material is then fed to a chemical separation process 120 depicted in further detail in FIG. 1B. Referring now to FIG. 1B, an embodiment of an industrial-scale process 120 for chemically separating lithium-ion battery components is illustrated. In a slurry formation step 121 of the chemical separation process 120, the roasted material output from eddy current separation step 116 of the physical separation process 110 is combined with water to form a slurry. In a flotation step 122 of the chemical separation process 120, the slurry is separated into a concentrate and tails, which are subjected to separate filter press steps 123, 124 of the chemical separation process 120. The solids resulting from the filter press 123 of the concentrate are subjected to a drying step 125 of the chemical separation process 120 to recover graphite, while the filtrates from both filter press steps 123, 124 are sent to a lithium recovery step 126 of the chemical separation process 120, which produces both lithium salts and water that can be recycled for use in slurry formation step 121. In an acid digestion (or acid leaching) step 127 of the chemical separation process 120, the solids resulting from the filter press 124 of the tails are digested and/or leached using sulfuric acid, nitric acid, or a combination or mixture thereof to form a leach liquor. The leach liquor is then filtered in filtering step 128 of the chemical separation process 120 to remove graphite and/or plastics, and then subjected to a copper electrowinning step 129 of the chemical separation process 120 to remove copper; it is to be expressly understood that the leach liquor may be stored in and/or recycled to a leach liquor tank, such that at least a portion of the leach liquor is subjected to multiple passes in copper electrowinning step 129. After copper electrowinning step 129, the remaining leach liquor is then fed to a cobalt and nickel recovery process 130 depicted in further detail in FIG. 1C.

Referring now to FIG. 1C, an embodiment of an industrial-scale process 130 for recovering cobalt and nickel from lithium-ion battery components is illustrated. In an impurity precipitation step 131 of the cobalt and nickel recovery process 130, the leach liquor output from copper electrowinning step 129 of the chemical separation process 120 is combined with a precipitating agent, e.g. sodium carbonate, to cause aluminum-, copper-, and iron-containing impurities to precipitate out of the leach liquor. In a carbonate precipitation step 132 of the cobalt and nickel recovery process 130, the same or a different precipitating agent is added to the leach liquor to cause the precipitation of further carbonate-containing precipitates. The remaining leach liquor is then filtered in a filtration step 133 of the cobalt and nickel recovery process 130, separating a sodium sulfate-containing liquid from the leach liquor from which cobalt and nickel are finally recovered. This leach liquor is then subjected to a cobalt and nickel electrowinning step 134 of the cobalt and nickel recovery process 130 to recover cobalt and nickel from the leach liquor; it is to be expressly understood that the leach liquor may be stored in and/or recycled to a leach liquor tank, such that at least a portion of the leach liquor is subjected to multiple passes in cobalt and nickel electrowinning step 134. The resulting cobalt and nickel, which is recovered in the form of a solid metallic alloy, is then subjected to a milling step 135 or similar processing step of the cobalt and nickel recovery process 130, to allow the cobalt/nickel metallic alloy to be size-reduced and/or otherwise placed in condition for sale to end users.

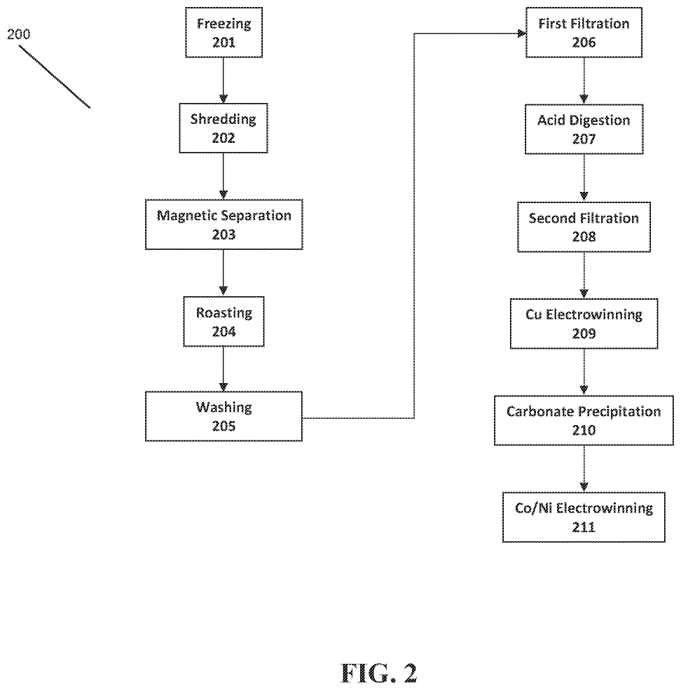

Referring now to FIG. 2, an embodiment of a bench-scale process for separating and recovering cobalt and nickel from lithium-ion battery components is illustrated. In a freezing step 201 of the bench-scale process 200, lithium-ion batteries are “frozen,” i.e. cooled to at least as low as 0° C., by a suitable cooling medium, such as, by way of non-limiting example, dry ice. In a shredding step 202 of the bench-scale process 200, the frozen lithium-ion batteries are shredded to produce a shredded material that is amenable to the downstream physical and chemical separation processing steps; the average size of pieces of the shredded material is preferably no more than about 20 mm, more preferably no more than about 19 mm, still more preferably no more than about 18 mm, still more preferably no more than about 17 mm, still more preferably no more than about 16 mm, still more preferably no more than about 15 mm, still more preferably no more than about 14 mm, still more preferably no more than about 13 mm, still more preferably no more than about 12 mm, still more preferably no more than about 11 mm, still more preferably no more than about 10 mm, still more preferably no more than about 9 mm, still more preferably no more than about 8 mm, still more preferably no more than about 7 mm, and still more preferably no more than about 6 mm, to minimize the probability of a thermal event due to the tendency of the pieces of shredded material to “short-circuit.” In a magnetic separation step 203 of the bench-scale process 200, steel casings are removed from the shredded material via magnetic separation. In a roasting step 204 of the bench-scale process 200, the shredded material is roasted to produce a roasted material; the temperature and time of the roasting step 204 is preferably selected to allow for the breakdown of binder materials (e.g. polyvinylidene fluoride (PVFD)) in the lithium-ion batteries and liberation of the cathode powder while preventing oxidation of metallic aluminum and copper. In a washing step 205 of the bench-scale process 200, the roasted material is washed with an aqueous fluid to dissolve lithium compounds, e.g. lithium fluoride. In a first filtration step 206 of the bench-scale process 200, the water-washed roasted material is filtered to separate a liquid comprising water and dissolved lithium compounds from the remaining solids of the roasted material. In an acid digestion (or acid leaching) step 207 of the bench-scale process 200, the solids resulting from filtration step 206 are digested and/or leached using sulfuric acid, nitric acid, or a combination or mixture thereof to form a leach liquor. In a second filtration step 208 of the bench-scale process 200, the leach liquor is filtered to remove graphite therefrom. In a copper electrowinning step 209 of the bench-scale process 200, copper is removed from the leach liquor by electrowinning. In an impurity precipitation step 210 of the bench-scale process 200, the leach liquor output from copper electrowinning step 209 of the bench-scale process 200 is combined with a precipitating agent, e.g. sodium carbonate, to cause aluminum-, copper-, and iron-containing impurities to precipitate out of the leach liquor. In a carbonate precipitation step 210 of the bench-scale process 200, the same or a different precipitating agent is added to the leach liquor to cause the precipitation of further carbonate-containing precipitates. The remaining leach liquor is then subjected to a cobalt and nickel electrowinning step 211 of the cobalt and nickel recovery process 130 to recover cobalt and nickel from the leach liquor.

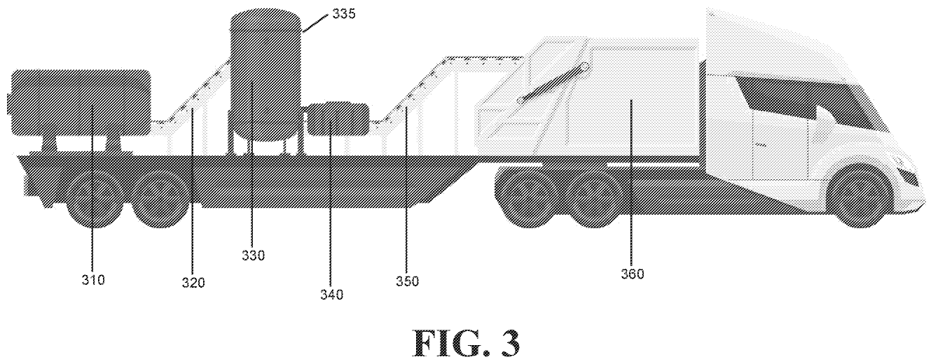

Referring now to FIG. 3, an embodiment of a system 300 for on-site cooling and shredding of lithium-ion batteries prior to transport is illustrated. Lithium-ion batteries are first placed in an insulated compartment 310 and rapidly “frozen,” using a suitable very low-temperature cooling medium (e.g. liquid nitrogen), to a selected cryogenic temperature, which may in some embodiments be about −80° C. From the insulated compartment 310, the frozen batteries are carried via a first non-conductive conveyance mechanism 320 to the top of a shredder 330; the first non-conductive conveyance mechanism 320 is insulated to maintain the cryogenic temperature of the frozen batteries. After entering the top of the shredder 330, the frozen batteries are shredded by the shredder 330 to produce a shredded material that is amenable to the downstream physical and chemical separation processing steps; the average size of pieces of the shredded material is preferably no more than about 20 mm, more preferably no more than about 19 mm, still more preferably no more than about 18 mm, still more preferably no more than about 17 mm, still more preferably no more than about 16 mm, still more preferably no more than about 15 mm, still more preferably no more than about 14 mm, still more preferably no more than about 13 mm, still more preferably no more than about 12 mm, still more preferably no more than about 11 mm, still more preferably no more than about 10 mm, still more preferably no more than about 9 mm, still more preferably no more than about 8 mm, still more preferably no more than about 7 mm, and still more preferably no more than about 6 mm, to minimize the probability of a thermal event due to the tendency of the pieces of shredded material to “short-circuit.” The shredder 330 is also preferably configured to ensure a selected temperature increase in the shredded material as a result of the shredding process; in some embodiments, e.g. where the frozen batteries enter the shredder 330 at a temperature of about −80° C., the selected temperature increase may be about 40° C., e.g. to result in a temperature of the shredded material exiting the shredder of about −40° C. The shredder 330 is fitted with a vapor scrubber 335, which allows for scentless operation of the shredder 330 and compliance with applicable emissions standards. From the shredder 330, the shredded material is then passed to a water bath unit 340, where the material is washed with a fluid comprising water and, optionally but preferably, one or more pH buffers or other pH control agents to allow the water to be continuously reused. From the water bath 340, the washed shredded material is carried via a second non-conductive conveyance mechanism 350 to a packing container 360. The packing container 360 is a secure container that allows the washed material to be packed tightly for transport and ultimate unloading for use in the cobalt and nickel recovery methods and systems, and related processes, of the invention.

To maximize the effectiveness of the acid leaching steps of the methods of the present invention, it is preferable to separate, to the greatest extent feasible, any aluminum, copper, and iron present in the roasted material prior to the acid leaching. Copper and iron can generally be effectively separated by a combination of magnetic, mechanical screening and/or shaking, and eddy current methods, but separation of aluminum can be challenging because the aluminum collector is generally firmly attached to the cathode metallic oxides. The present inventors overcome this issue by employing either or both of (1) roasting at low temperatures and/or for short times to “burn” the binder material, e.g. polyvinylidene fluoride (PVFD), without oxidizing the aluminum collector, followed by separation of the cathode metallic oxides from the aluminum foil collector, and (2) using ultrasound to delaminate the oxides from the aluminum collector.

The end product of the methods and systems of the present invention is a cobalt/nickel metallic alloy in the form of a thin, generally cylindrical sheet. As many end users will desire this alloy in a powdered form, the methods and systems of the invention may suitably comprise an additional processing step comprising conventional size reduction (e.g. grinding) before the alloy is delivered to the end user. Many such size reduction or similar processing methods are well-known, and those of ordinary skill in the art will be able to select an appropriate size reduction or similar processing method, and the appropriate conditions and parameters therefor, based on the needs of any particular application.

Because cobalt is a “conflict resource” (i.e. a resource that is extracted in an area of ongoing armed conflict and sold to perpetuate that conflict), the present inventors anticipate that cobalt will, in the coming years, become more difficult and/or expensive to obtain, and that battery manufacturers will likely redesign the chemistries of their batteries to reduce or eliminate the need for cobalt. If and when this occurs, the advantages of the methods and systems of the present invention will become even more significant, as such methods and systems will produce a very high-purity nickel product, without the need to further separate cobalt or modify a cobalt/nickel ratio.

A first non-limiting example of applications for the metallic alloys produced by the present invention is in the manufacture of high-performance alloys or “superalloys,” i.e. alloys that maintain their mechanical strength, resistance to thermal creep, surface stability, and resistance to corrosion and oxidation even at temperatures representing a significant fraction of the alloys' melting point. The present inventors estimate that the superalloy industry requires approximately 110 kilotons of nickel each year, and that this nickel must be of an extremely high purity, i.e. less than about 20 ppmw of impurities. The present invention is suitable for meeting these needs.

A second non-limiting example of applications for the metallic alloys produced by the present invention is in the manufacture of stainless steels. The present inventors estimate that the stainless steel industry requires approximately 1,470 kilotons of nickel each year, and that this nickel must contain less than about 170 ppmw of impurities. The present invention is suitable for meeting these needs.

A third non-limiting example of applications for the metallic alloys produced by the present invention is in the manufacture of specialty steels, such as high-strength low-alloy (HSLA) steels. The present inventors estimate that the specialty steel industry requires approximately 37 kilotons of nickel each year, and that this nickel must contain less than about 200 ppmw of impurities. The present invention is suitable for meeting these needs.

The invention is further characterized by the following non-limiting Examples.

### Example 1:

### Preparation of Feedstock and Shredding of Batteries

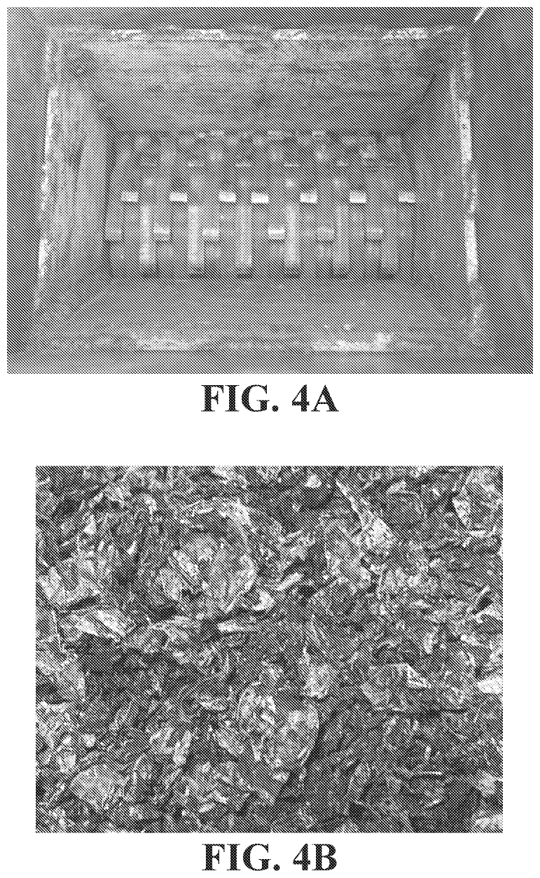

64 Tesla 2170-type NCA cells were cooled to −20° C. and shredded in a custom single-shaft shredder, the grinding wheel assembly of which is illustrated in FIG. 4A. The particle size of the resulting shredded material was between 6 millimeters and 20 millimeters. It was observed that the larger shredded particles tended to behave like a short-circuited battery and therefore had the potential to cause a thermal event; the shredded material was therefore passed through the shredder a second time to reduce the size of the larger particles. This shredded material was then subjected to manual magnetic separation to eliminate most of the steel casings present in the shredded material. After magnetic separation, the shredded material was immersed and stored in distilled water to ensure the safe shipment of the material. This final shredded material is illustrated in FIG. 4B; the white-colored particles are remnants of the plastic membrane of the batteries, the gold-colored particles are copper, and the green and red particles are pieces of various other plastics used in the manufacture of the batteries.

The total mass of the dry shredded material was not recorded, but the total mass of the wet shreds used in the roasting experiment of Example 2 below was recorded as 3,690 grams. The magnetic separation also recovered 200 grams of a dry powder, which was measured as containing 32 wt % nickel and 1.6 wt % cobalt; this dry powder was then fed directly into the acid leaching process of Example 3 below.

The present inventors made several valuable observations in the course of the feedstock preparation and battery shredding process of this Example. First, it was observed that some fine particles of material were lost during shredding in an open environment; shredding in a closed environment may allow these fine particles to be captured, if desired. Second, as discussed above, larger particles exiting the shredder, if not further size-reduced, tend to increase the likelihood of a thermal event, largely due to output size from the shredder; more rapid and/or finer shredding of the batteries appears to be effective for reducing the potential for thermal events. Third, as the batteries have a tendency to crush rather than shred in the single-shaft grinding wheel mechanism of this shredder, an alternative shredding mechanism may be preferred to improve the shred efficiency and crush resistance of the batteries. Fourth, the dry black powder material recovered during the magnetic separation tends to be carried on and/or adhere to the steel casings during magnetic separation; the overall metal oxide recovery is likely to be improved if this powder is further separated from the steel casings downstream.

### Example 2:

### Roasting

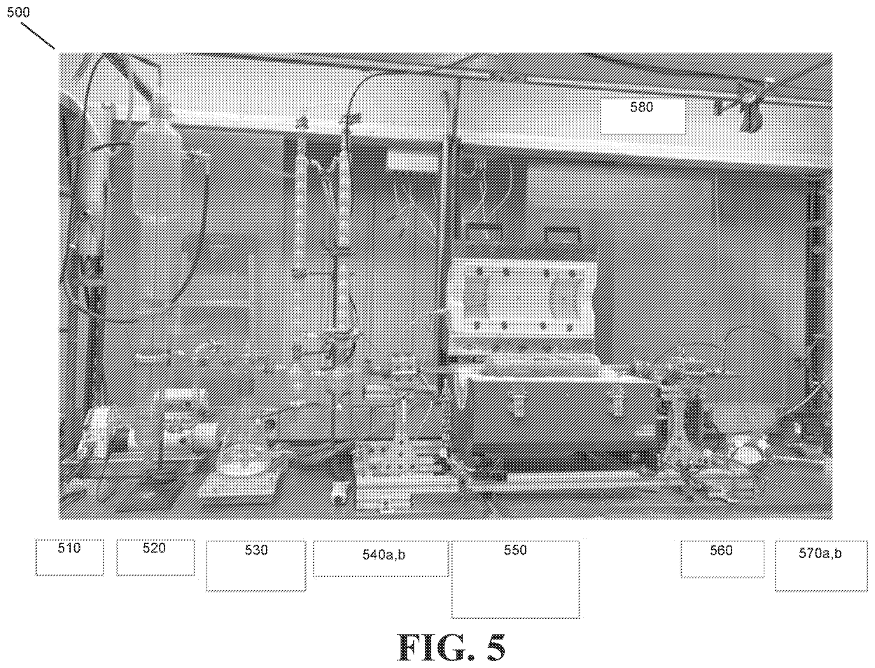

Referring now to FIG. 5, an embodiment of a system 500 for roasting the shredded material depicted in FIG. 4B according to the process depicted in FIG. 2 is illustrated. The system 500 includes a pilot flame burner 510, an electrostatic particle trap 520, a sodium hydroxide bubbler 530 to impose a positive pressure of about 2 psi, condensing units 540a,b including at least one condensate takeout port, a quartz rotary kiln 550 (tumble dimples at three independently controlled heating sections, configured to rotate at 1 rpm), a charge thermocouple 560, flow meters 570a,b (controlling flow rates of oxygen and nitrogen gases, respectively, to ensure a total gas flow rate of 3 liters per minute), and an exhaust gas conduit 580 conveying an exhaust gas to an exhaust gas analyzer.

A roasting temperature of 450° C. was selected for roasting the shredded material produced in Example 1, and the process was conducted under oxidizing conditions including 20% oxygen gas; the flow of gases is from right to left in FIG. 5. The incoming gas composition was controlled via mass flow meters 570a,b, and the contents of carbon monoxide, carbon dioxide, oxygen gas, and sulfur dioxide in the exhaust gas were measured by the exhaust gas analyzer. The pH of the sodium hydroxide bubbler 530 was recorded at the start of the roast and at the end of the roast, when the carbon dioxide content of the exhaust gas fell below 1%; as expected, the pH of the solution in the sodium hydroxide bubbler 530 fell from 14 at the start of the roast to 11 at the end of the roast, indicating the presence of acid gases in the exhaust.

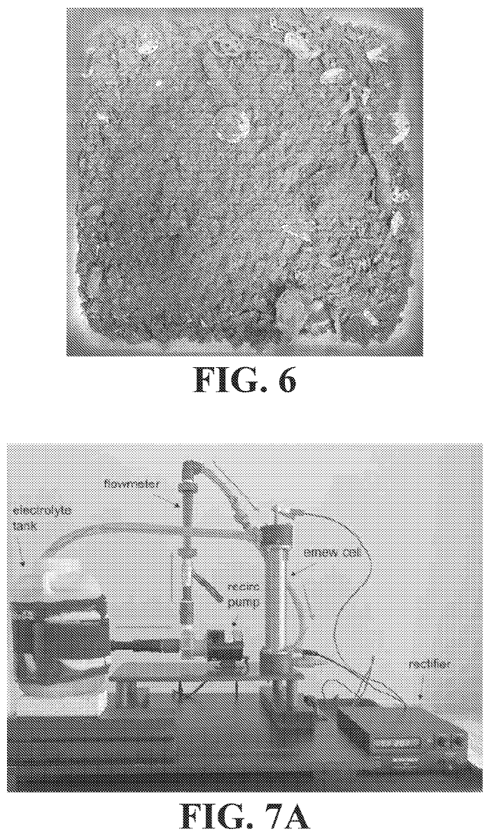

Following roasting, the roasted material was screened through a ¼″ mesh to eliminate larger pieces of aluminum and steel remaining in the roasted material. As a result, the roasted material ultimately sent on to the acid leaching process of Example 3 had a very low iron content. This final material sent for acid leaching consisted mainly of a gray powder with scattered larger pieces, as illustrated in FIG. 6.

The total weight of the final roasted material sent for acid leaching was 2,064 grams. The elemental content of this material was analyzed, and the results of this analysis are given in Table 1 (totals do not add to 100% because most aluminum, cobalt, copper, and nickel are present as oxides and oxygen content was not determined).

TABLE 1
Elemental content of roasted material after ¼″ screening

| Element | Wt % |
|---|---|
| Nickel | 26.0 |
| Cobalt | 1.34 |
| Manganese | 0.0051 |
| Iron | 0.333 |
| Lithium | 3.87 |
| Copper | 9.59 |
| Aluminum | 5.65 |
| Phosphorus | 0.551 |
| Fluorine | 2.04 |
| Chromium | 0.0054 |
| Carbon (total) | 23.9 |
| Carbon (acid-insoluble) | 22.2 |

The significant quantity of carbon present is particularly noteworthy. The primary source of this carbon is the anodes of the NCA batteries used in this Example, which consist principally of graphite; this can be confirmed by observing that the substantial majority of the carbon is not soluble in the acid used in the acid leaching of Example 3, indicating a low carbonate content.

The theoretical maximum mass of metal that can be recovered from 64 Tesla 2170-type NCA cells was calculated as 857 grams of nickel and 108 grams of cobalt. The 2,064 grams of roasted material obtained by the process of this Example contained 536 grams of nickel and 27.7 grams of cobalt, and the 200 grams of metallic powder obtained from the shredding process of Example 1 contained 64 grams of nickel and 3.2 grams of cobalt. Thus, in total, 70% of the nickel, 29% of the cobalt, and 65% of the total combined mass of nickel and cobalt was retained after the shredding and roasting processes of Examples 1 and 2.

The present inventors made several valuable observations in the course of the roasting process of this Example. First, it is likely preferable to decrease the temperature and/or time of the roasting process relative to this Example. In this exemplary run, substantially all of the copper and aluminum collector foils were oxidized, but it is desirable to keep these metals in metallic form to make it easier to separate them prior to the acid leaching step; lower temperatures and/or shorter roast times would allow for the breakdown of binder materials, e.g. polyvinylidene fluoride (PVFD), and liberation of the cathode powder, but would prevent the metallic aluminum and copper from oxidizing. Second, in this Example, the separation of iron was performed via post-roast screening to eliminate steel pieces that remained in the “jelly rolls” of the shredded material; a similar step may be necessary in larger-scale processes depending on the viability of post-shredding separation of iron. Third, it was observed that acids generated during roasting will likely need to be scrubbed in industrial-scale processes.

### Example 3:

### Leaching

Before the roasted material of Example 2 was acid-leached, it was washed with water to dissolve and remove any fluorine compounds remaining in the shredded material, as fluorine is known to degrade electrode materials in downstream processing steps, e.g. the electrowinning processes of Examples 4 and 5. The fluid left over from the water washing step will generally include various soluble lithium compounds, e.g. lithium fluoride and/or lithium hydroxide; though not carried out in this Example, it may be possible for the wash fluid to be subjected to a downstream lithium recovery process, e.g. by ion exchange and precipitation.

After the water wash, the remaining solids were filtered and then dissolved in a combination of sulfuric acid and nitric acid; the present inventors have observed that the addition of nitric acid improves the kinetics of acid leaching. The inventors further observed, but did not vary, the process parameters of the acid leaching, e.g. solid/liquid ratio, acid concentration, leaching time, leaching temperature, etc. These parameters can, and preferably will, be optimized in industrial-scale processes to maximize the effectiveness of subsequent electrowinning steps.

After acid leaching, the leach liquor was filtered using a vacuum press and a 1 μm filter. It was observed that this filtration step proceeded extremely slowly because the filter repeatedly became clogged with graphite particles. After filtration, the final filtered leach liquor contained nickel and cobalt at a concentration of 72 grams per liter and was deemed suitable for the copper electrowinning step of Example 4.

The present inventors made several valuable observations in the course of the leaching process of this Example. First, although nitric acid was used to accelerate the kinetics of acid leaching, it may be possible, instead of or in addition to nitric acid, to supply oxygen gas for use as an oxidant in the acid leaching (the inventors consider hydrogen peroxide to be likely unsuitable as an oxidant, both because of its cost and because it is highly exothermic and can therefore cause difficulties in process control). Second, it is highly preferable to separate graphite from the leach liquor before final filtration to prevent clogging or saturation of the filter; froth flotation is likely to be a suitable process. Third, the exothermic dilution of the acids used for the leaching process can be harnessed to accelerate the kinetics of the leaching without requiring additional energy inputs from an extrinsic source (e.g. heating).

### Example 4:

### Copper Electrowinning

The inventors have observed that the most crucial specification to achieve in the final cobalt/nickel metallic alloy product of the methods and systems of the present invention is a low copper content, especially when the metallic alloy product is to be used in high-performance alloys or “superalloys.” While copper contents of up to about 50 ppmw may be acceptable for some high-performance alloys, prime stock quality can only be achieved with copper contents of no more than about 10 ppmw. Thus, it is desirable in many embodiments to remove copper from the leach liquor separately from the recovery of cobalt and nickel. Because copper has a high standard reduction potential, it is more favorably reduced from the leach liquor via electrowinning than cobalt or nickel; thus, an additional electrowinning step to specifically remove copper prior to the cobalt/nickel electrowinning can be effective, especially for relatively copper-rich leach liquors.

It is to be understood that copper electrowinning is not a crucial or necessary step in the practice of the present invention, and in some embodiments it may be preferable to omit copper electrowinning altogether. Particularly, if a large proportion of the copper has been removed from the shredded or roasted battery material by an upstream processing step (e.g. by physical separation following shredding), it may be possible to omit the electrowinning step. Although the electrolytic process of copper electrowinning is not energy-intensive, it can be time-consuming to reduce the copper content of the leach liquor to saleable levels by electrowinning alone; thus, a greater degree of copper removal upstream can eliminate the need for, or reduce the time of, a copper electrowinning step and decrease the quantity of acid required for acid leaching.

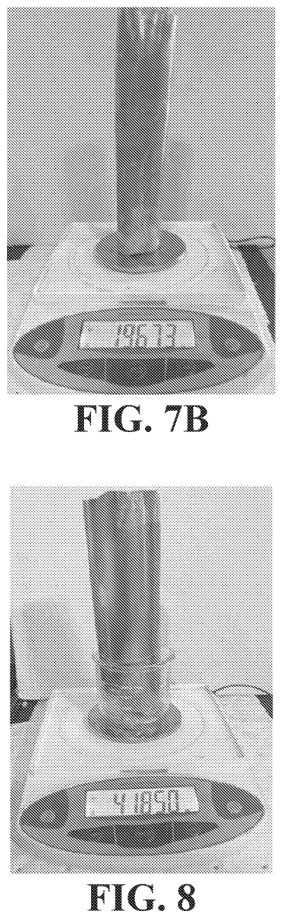

In this exemplary run, the copper content of the leach liquor was reduced to 7,000 ppmw by electrowinning, although the present inventors hypothesize that levels at least as low as 1,000 ppmw are achievable. The electrowinning equipment is illustrated in FIG. 7A, and the resulting copper product is illustrated in FIG. 7B. After the electrowinning, the leach liquor was neutralized with sodium carbonate to preferentially precipitate aluminum-, copper-, and iron-containing impurities before precipitation of carbonates of cobalt and nickel, thereby ensuring low levels of copper in the final cobalt/nickel product. The filtered carbonate cake contained less than 1 ppmw of aluminum, copper, and iron; about 7% of the nickel in the leach liquor was lost during this step, but the present inventors hypothesize that this can be reduced to at least as low as 5%.

The present inventors made several valuable observations in the course of the copper electrowinning process of this Example. First, a very high-purity copper product can be obtained via electrowinning; the copper product obtained in this Example was 99.99 wt % copper, with the major impurity being 29 ppmw of iron. Second, a copper electrowinning process can remove a significant proportion of the copper from the leach liquor; in this exemplary run 70% of the copper was recovered via this separate electrowinning step, but even higher recoveries are possible. Third, reducing the content of aluminum, copper, and iron in the leach liquor by upstream processing steps will reduce the time required for the electrowinning step (or even eliminate the need for such a step entirely) and the amounts of aluminum, copper, and iron that must be precipitated, with corresponding reductions in the amounts of acid and precipitating agent required. Fourth, the copper recovery rate was relatively insensitive to the copper concentration in the liquor, suggesting that copper concentrations at least as low as 1,000 ppmw (i.e. about 1 gram per liter) can be achieved even before precipitation. Fifth, where the copper concentration of the leach liquor after the leaching process is about 3 grams per liter or less, it may be less desirable or unnecessary to conduct a separate copper electrowinning step.

### Example 5:

### Cobalt and Nickel Electrowinning

The final electrowinning step to remove cobalt and nickel from the leach liquor is generally analogous to the copper electrowinning step described in Example 4 above. After reduction of the copper via electrowinning and precipitation as described in Example 4, 356 grams of metal carbonates were redissolved in 2 liters of 1.8M sulfuric acid and then adjusted to a pH of 3 using sodium carbonate and boric acid. The plated cobalt and nickel, illustrated in FIG. 8, were harvested from the cell and analyzed for impurities. This analysis showed a purity (i.e. a proportion of the recovered product consisting of cobalt and nickel) of 99.7 wt %, with 3,072 ppmw of copper and 120 ppmw of iron as impurities. While the copper content of the metallic alloy product is surprisingly high, given the low copper content of the metal carbonate cake, it was found that this was due to residual copper contamination on the cathode cell tube.

The present inventors made several valuable observations in the course of the cobalt and nickel electrowinning process of this Example. First, the purity of the cobalt/nickel metallic alloy product can be still further improved with refinements to the process setup, and a copper content of less than about 25 ppmw can be achieved so long as contamination of the cathode tubes with copper is avoided. Second, the overall efficiency of the metal recovery process was 84%, proving that the methods and systems of the invention are effective for recovering significant proportions of the cobalt and nickel from lithium-ion batteries. Third, the total recovery of nickel, from the whole lithium-ion batteries (prior to Example 1) through to the final cobalt/nickel electrowinning product, was 83%, which can be expected to increase to at least about 87% after reprocessing of intermediate precipitates from the purification processes.

In total, the processing of lithium-ion batteries according to the bench-scale processes and methods described in Examples 1 through 5 yields several notable findings. First, the majority of the metallic losses were realized early in the method of the invention, during the initial shredding and roasting steps, and more precise control of process conditions can enable significant reductions in these metallic losses and therefore greater recoveries of metals downstream. Second, effective and rapid size reduction of the lithium-ion batteries by shredding avoids the possibility of thermal events caused by larger particles of shredded battery material and is thus essential for process safety. Third, acid gases are generated via oxidation during roasting; these gases will generally need to be captured and scrubbed in industrial-scale processes. Fourth, the initial acid leach is the most expensive step in the process due to the cost of the reactants required, and process optimization should be focused on reducing the costs of the acid leach to the extent possible. Fifth, a lithium removal step before the leaching process begins is highly desirable, both to improve the effectiveness of downstream processing steps and to obtain an additional valuable product (i.e. lithium compounds). Sixth, a graphite removal step before the leaching process beings is highly desirable, both to prevent clogging/saturation of downstream filtration steps and to obtain an additional valuable product (i.e. graphite). Seventh, the most significant cost modeling parameters are likely to be the kinetics of acid leaching/digestion, acid consumption rates in the leaching process, and the energy demands of the leaching and electrowinning processes; these parameters should likewise be a focus of process optimization. Eighth, a copper electrowinning step followed by copper precipitation is likely to be generally sufficient to reduce the copper content in the final cobalt/nickel alloy to level suitable for use in superalloys. Ninth, the end cobalt/nickel alloy product will be useful not only in the manufacture of superalloys, but also in the manufacture of stainless steels and high-performance steels as well.

The invention illustratively disclosed herein suitably may be practiced in the absence of any element which is not specifically disclosed herein. It is apparent to those skilled in the art, however, that many changes, variations, modifications, other uses, and applications of the invention are possible, and also changes, variations, modifications, other uses, and applications which do not depart from the spirit and scope of the invention are deemed to be covered by the invention, which is limited only by the claims which follow.

The foregoing discussion of the invention has been presented for purposes of illustration and description. The foregoing is not intended to limit the invention to the form or forms disclosed herein. In the foregoing Detailed Description of the Invention, for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description of the Invention, with each claim standing on its own as a separate preferred embodiment of the invention.

Moreover, though the description of the invention has included description of one or more embodiments and certain variations and modifications, other variations, combinations, and modifications are within the scope of the invention, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, whether or not such alternate, interchangeable, and/or equivalent structures, functions, ranges, or steps are disclosed herein, and without intending to publicly dedicate any patentable subject matter.

1. A method for recovering metals, comprising:
(a) shredding at least one lithium-ion battery to form a shredded material;
(b) roasting the shredded material to form a roasted material;
(c) acid-leaching the roasted material to form a leach liquor comprising cobalt and nickel; and
(d) electrowinning the leach liquor to form a recovered metal product comprising at least about 50% of the cobalt in the leach liquor and at least about 50% of the nickel in the leach liquor.

2. The method of claim 1, wherein the leach liquor further comprises copper, wherein at least most of the copper is recovered from the leach liquor by copper electrowinning.

3. The method of claim 2, wherein the copper electrowinning is carried out as part of step (d).

4. The method of claim 2, wherein the copper electrowinning is carried out as an electrowinning step separate from step (d).

5. The method of claim 1, wherein a temperature of the lithium-ion battery is no more than about 0° C. during step (a).

6. The method of claim 1, further comprising, between steps (a) and (b), removing steel filings from the shredded material via magnetic separation.

7. The method of claim 1, wherein step (b) is carried out at a temperature of no more than about 450° C.

8. The method of claim 1, further comprising, between steps (b) and (c), washing, with a fluid comprising water, and filtering the roasted material to remove fluorine compounds from the roasted material.

9. The method of claim 1, wherein an acid used to perform the acid-leaching of step (c) is selected from the group consisting of sulfuric acid, nitric acid, and combinations and mixtures thereof.

10. The method of claim 1, further comprising, between steps (c) and (d), filtering the leach liquor to remove graphite from the leach liquor.

11. The method of claim 1, further comprising, between steps (c) and (d) or during step (d), adding a precipitating agent to the leach liquor to form at least one of an aluminum-containing precipitate, a copper-containing precipitate, an iron-containing precipitate, and a carbonate-containing precipitate.

12. The method of claim 11, wherein the precipitating agent comprises sodium carbonate.

13. The method of claim 1, wherein cobalt and nickel make up at least about 99.7 wt % of the recovered metal product.

14. The method of claim 1, wherein copper makes up no more than about 25 ppmw of the recovered metal product.

15. The method of claim 1, wherein the recovered metal product comprises at least about 80% of the nickel in the leach liquor.

16. A method for preparing a material for use in a metal recovery process, comprising:
(a) cooling a lithium-ion battery to a temperature at least as low as 0° C.;
(b) shredding the lithium-ion battery while maintaining the temperature of the lithium-ion battery at least as low as 0° C., thereby forming a shredded material;
(c) washing the shredded material with a fluid comprising water to form a washed material; and
(d) packing the washed material for transport.

17. The method of claim 16, wherein the temperature in step (a) is about −80° C.

18. The method of claim 16, wherein the temperature in step (b) is about −40° C.

19. The method of claim 16, wherein the fluid in step (c) further comprises a pH buffer or pH control agent.

20. The method of claim 16, wherein the shredding of step (b) produces a vapor and step (b) comprises the sub-step of remediating the vapor.
